(19) United States
(12) Patent Application Publication
(10) Pub. No.: US 2026/0081869 A1
(43) Pub. Date: Mar. 19, 2026

(54) SYSTEMS AND METHODS TO ACHIEVE HIGH PERFORMANCE PACKET PROCESSING AND DATA CORRELATION

(71) Applicant: Aviz Networks, Inc., San Jose, CA (US)

(72) Inventors: Chidambaram Bhagavathiperumal, Livermore, CA (US); Harrish Subramaniam Jeyabalu, Coimbatore (IN); Ilanchezhian Raman, Chennai (IN); Ashok Kumar Murthy, Chennai (IN)

(73) Assignee: Aviz Networks, Inc., San Jose, CA (US)

(21) Appl. No.: 18/885,552

(22) Filed: Sep. 13, 2024

(51) Int. Cl. H04L 47/125; H04W 8/20

(52) U.S. Cl. CPC H04L 47/125; H04W 8/20

(57) ABSTRACT

In some implementations, the method may include receiving a control packet. In addition, the method may include decoding the control packet once it has been received. The method may include initiating a session tracking of the control packet. Moreover, the method may include extracting subscriber information from the control packet to create extracted control information. Also, the method may include storing the extracted control information into a control hash database. Further, the method may include receiving a user plane packet. In addition, the method may include load-balancing and packet-preprocessing the user plane packet. The method may include extracting tunnel information from the user plane packet to create extracted tunnel information. Moreover, the method may include matching, by a correlation engine, the extracted tunnel information with the extracted control information to create correlated data. Also, the method may include executing, by the correlation engine, a performance action.

### BACKGROUND

The massive growth in the speed and data requirements of telecom networks has led to a situation where correlation devices must handle high speed packet processing and process control and user packets. A failure to process control and user packets at high-speed results in a low correlation percentage which creates poor network conditions. However, current methods fail to adequately correlate control information and user information at the speed required to handle such massive data requirements.

The N3 interface in 5G networks is the connection between the Radio Access Network (RAN) and the User Plane Function (UPF). It carries user data (like internet traffic) between the 5G base stations and the core network. Essentially, it's the path that user data takes as it moves from your device through the 5G network and eventually to the internet or other services.

In conventional 5G networks, data packets sent through the N3 interface don't currently include important information that identifies users or devices known as control information. This information is typically shared through other channels. This makes it difficult for telecom companies to efficiently determine which data belongs to which user or device when sending data between 5G devices and the internet. This lack of efficient correlation causes major problems in areas such as billing, security, and performance.

What is needed is better methods of correlation between control information and user information to address these issues.

### SUMMARY

According to some implementations, the methods of the present disclosure may include exchanging control packets before initiating one or more user plane sessions, where the control packets are tapped and analyzed to extract the below relevant information.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, method may include receiving a control packet. The method may also include decoding the control packet once it has been received. The method may furthermore include initiating a session tracking of the control packet.

The method may in addition include extracting subscriber information from the control packet to create extracted control information. The method may moreover include storing the extracted control information into a control hash database. The method may also include receiving a user plane packet. The method may furthermore include load-balancing and packet-preprocessing the user plane packet.

The method may in addition include extracting tunnel information from the user plane packet to create extracted tunnel information. The method may moreover include matching, by a correlation engine, the extracted tunnel information with the extracted control information to create correlated data. The method may also include executing, by the correlation engine, a performance action.

Other embodiments of this aspect include corresponding computer systems, apparatus, and computer programs recorded on one or more computer storage devices, each configured to perform the actions of the methods. Said methods are further detailed in the detailed description provided below.

### BRIEF DESCRIPTION OF THE DRAWINGS

FIG. 1 shows a lockless multi-core system according to an embodiment of the present disclosure.

FIG. 2 illustrates a 5G architecture that emphasizes the user plane interfaces, which are critical for managing data traffic in the network.

FIG. 3 shows a lockless multi-core system where each core operates independently without the need for locks, enhancing performance and reducing latency.

FIG. 4 shows an architecture flow according to an embodiment of the present disclosure.

FIG. 5 is a flow chart of a process of data correlation, according to an example of the present disclosure.

### DETAILED DESCRIPTION

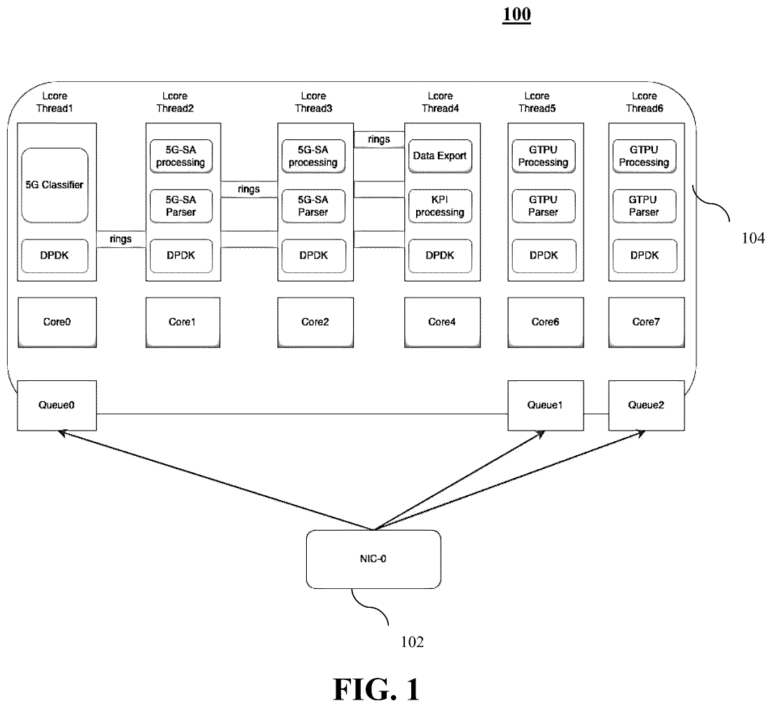

FIG. 1 shows a lockless multi-core system 100 according to an embodiment of the present disclosure. As shown in FIG. 1, each core of architecture 104 is assigned dedicated memory and specific functionalities which enable parallel processing without the need for synchronization mechanisms like locks. It can be appreciated that such a design minimizes contention and improves efficiency. This is because each core operates independently within its allocated tasks and memory space. This architecture is particularly useful in a high-performance environment such as a 5G network processing where speed and efficiency are necessary for optimal performance.

As shown in FIG. 1 Network Interface Card (NIC) 102 is connected to three queues: Queue0, Queue1, and Queue2. The queues are configured to distribute incoming data packets to different cores for processing. The lockless architecture of the system means that each core handles its tasks without interference from other cores which makes the system more scalable and responsive. According to an embodiment of the present disclosure, the number of queues/cores are dynamically decided based on the deployment bandwidth requirement.

According to an embodiment, Queue 0 is responsible for Lcore Thread 1, representing Core0, and is tasked with 5G classification and Data Plane Development Kit (DPDK) operations. The 5G classifier identifies and categorizes incoming 5G packets, while DPDK handles high-speed packet processing, ensuring that Core0 can efficiently process and forward data packets without delays.

According to an embodiment, Lcore Threads 2 and 3, corresponding to Core1 and Core2, are assigned to 5G-SA (Standalone) processing and 5G-SA parsing. These threads, in this example, handle the core functionalities of 5G-SA, such as managing the control plane and user plane separation, parsing incoming data packets, and processing them according to the 5G-SA protocols. By dedicating multiple cores to this task, the system can efficiently manage the high volume of data traffic inherent in 5G networks.

In this system, Lcore Thread 1 is also connected to Lcore Thread 2 via rings. Similarly, Lcore Thread 2 is connected to Lcore thread 3, and Lcore thread 3 is connected to Lcore thread 4 via rings. These rings act as communication channels, enabling the transfer of data between the cores. For instance, once Core0 has classified and processed a packet, it can send that packet to Core1 for further 5G-SA processing and parsing through these rings. The ring connections ensure that the data moves seamlessly between the cores without locking, allowing the system to maintain high performance.

Lcore Thread 4, representing Core4, focuses on data export, KPI (Key Performance Indicator) processing, and DPDK operations. According to an embodiment, Core4 is responsible for gathering and exporting data for analysis and reporting, processing KPIs to monitor network performance, and ensuring efficient packet handling with DPDK.

This division of tasks allows Core4 to streamline the monitoring and reporting functions without disrupting the flow of data through the network.

Finally, Lcore Threads 5 and 6, corresponding to Core5 and Core6, are dedicated to GTP-U (GPRS Tunneling Protocol User plane) processing, GTP-U parsing, and DPDK operations. In this embodiment, Queue1 corresponds to Lcore Thread 5 and Queue 2 corresponds to Lcore Thread 6.

GTP-U is essential for transmitting user data over the network, and these cores ensure that the data packets are properly parsed, processed, and forwarded. By dedicating multiple cores to GTP-U tasks, the system can handle the high throughput demands of 5G networks while maintaining low latency.

In the lockless multi-core system of FIG. 1 the distribution of specific tasks across dedicated cores and memory ensures efficient processing of 5G network traffic, reduces bottlenecks, and enhances overall system performance. Each core works independently, leveraging DPDK for fast packet processing, while the lockless design eliminates the need for synchronization mechanisms, further boosting the system's speed and responsiveness.

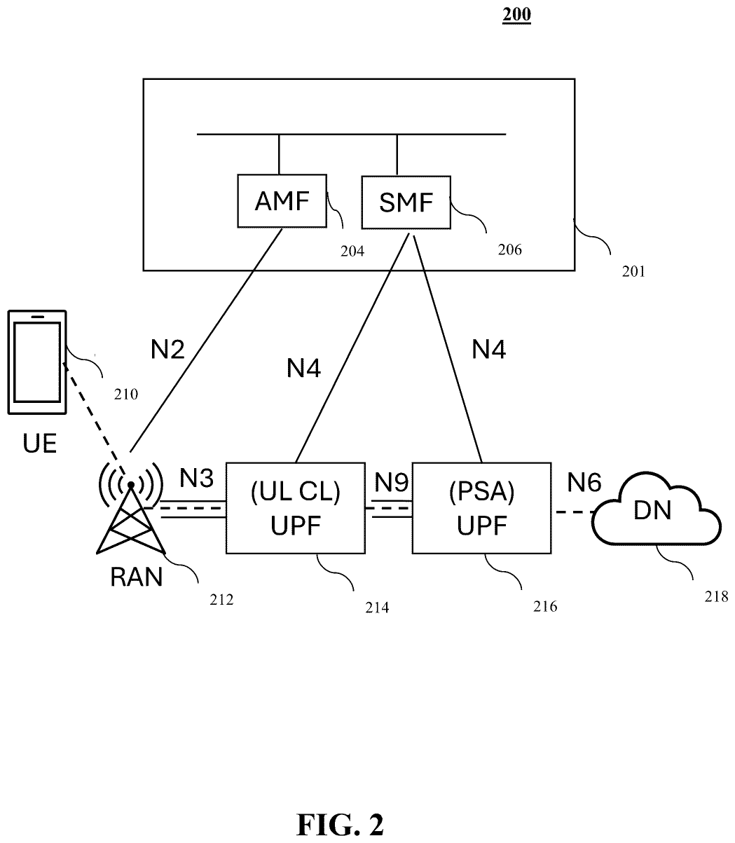

FIG. 2 illustrates a 5G architecture 200 that emphasizes the user plane interfaces, which are critical for managing data traffic in the network. The architecture follows a service-based approach, indicated by the service-based architecture 201, which is designed to provide modular and flexible network services in 5G networks.

This architecture facilitates the separation of control plane and user plane functions, allowing for more efficient and scalable network operations. AMF (Access and Mobility Management Function) 204 is responsible for handling signaling and control functions related to user equipment (UE) 210 access and mobility. It manages connections between the UE and the 5G network, including authentication, security, and mobility management. In this architecture, AMF 204 is connected to the RAN (Radio Access Network) 212 via the N2 interface, which is responsible for transmitting control plane messages between the RAN 212 and the core network.

SMF (Session Management Function) 206 is in charge of session management and allocation of IP addresses to the user equipment. It also handles the establishment, modification, and release of data sessions. SMF 206 communicates with the UPF (User Plane Function) 214 components via the N4 interface to manage user data sessions and ensure efficient data routing.

RAN (Radio Access Network) 212 is the component that provides wireless connectivity between the UE (User Equipment) 210 and the core network. In this architecture, the RAN 212 is connected to the UE 210 and serves as the intermediary for both control and user data transmissions. The RAN is connected to the AMF 204 via the N2 interface for control plane functions, and it is connected to the UPF 214 via the N3 interface for user plane data transmissions.

The N3 interface is crucial as it carries user data from the RAN to the UPF for further processing and forwarding. UPF (User Plane Function) 214 is a key component of the user plane in 5G networks. It handles the actual data traffic, including routing, forwarding, and packet inspection. In this architecture, UPF 214 is connected to the RAN 212 via the N3 interface, which carries user data, and to the SMF 206 via the N4 interface, which allows the SMF to control the data session parameters. PSA UPF (Packet Switching Anchor UPF) 216 serves as a packet forwarding entity and is responsible for anchoring user data sessions as they move across different networks or access points. It is connected to the SMF 206 via the N4 interface, ensuring that the SMF can manage session continuity and data routing.

The PSA UPF 216 is also connected to the Data Network (DN) 218 via the N6 interface, which is used to transmit data between the core network and external networks or services, such as the internet. DN (Data Network) 218 represents external networks or services that the user equipment interacts with, such as the internet, private enterprise networks, or cloud services. The DN 218 is connected to the PSA UPF 216 via the N6 interface, which handles the actual data transfer between the 5G network and external destinations.

The N9 interface links UPF 214 to PSA UPF 216, facilitating user data forwarding between different UPF instances, particularly when handling session continuity and mobility. This architecture exemplifies how the different components of a 5G network are interconnected through various interfaces, ensuring efficient handling of both control and user plane functions. By separating the control and user planes, it is possible to achieve greater increase flexibility and scalability of modern network services.

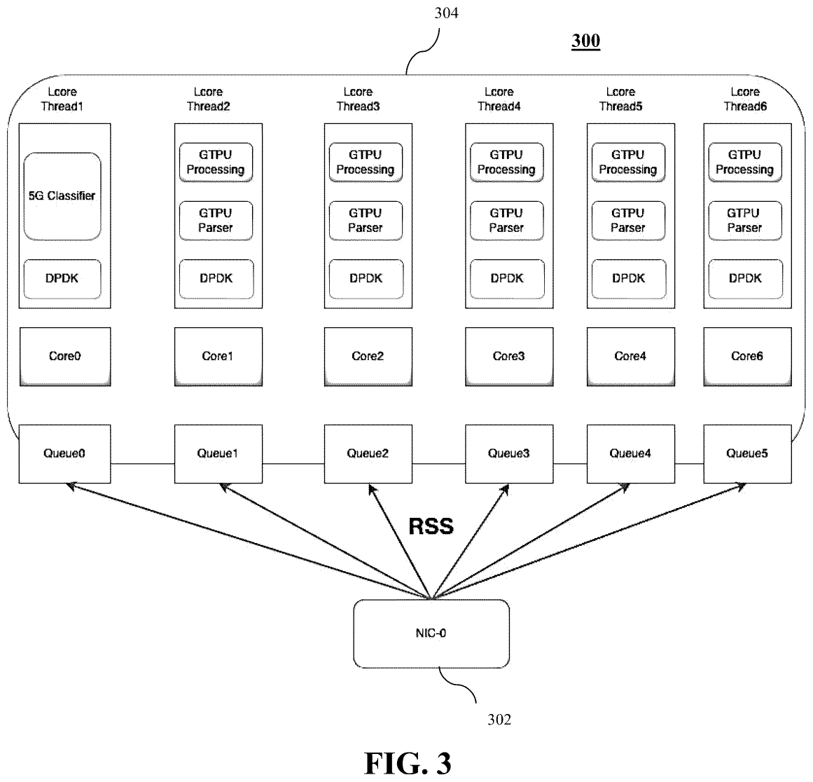

FIG. 3 shows a lockless multi-core system 300 where each core of architecture 304 operates independently without the need for locks, enhancing performance and reducing latency. NIC 302, which stands for Network Interface Card, is connected to each of Queues 0-5 via RSS, which stands for Receive Side Scaling, a technique used to distribute network traffic across multiple processor cores. Queue 0 corresponds to Lcore thread 1, which is responsible for handling the 5G classifier and DPDK (Data Plane Development Kit) operations. The 5G classifier categorizes and processes incoming 5G data packets, while DPDK enables fast packet processing to keep up with the high data rates of 5G networks.

Queues 1-5 correspond to Lcore threads 2-6, which are responsible for GTP-U (GPRS Tunneling Protocol User plane) processing, GTP-U parsing, and DPDK operations. GTP-U processing handles the user data being transmitted through the network, while the GTP-U parser breaks down the data packets for further analysis and routing. The DPDK component ensures that these operations are performed efficiently, making the system capable of handling large volumes of data with minimal delay.

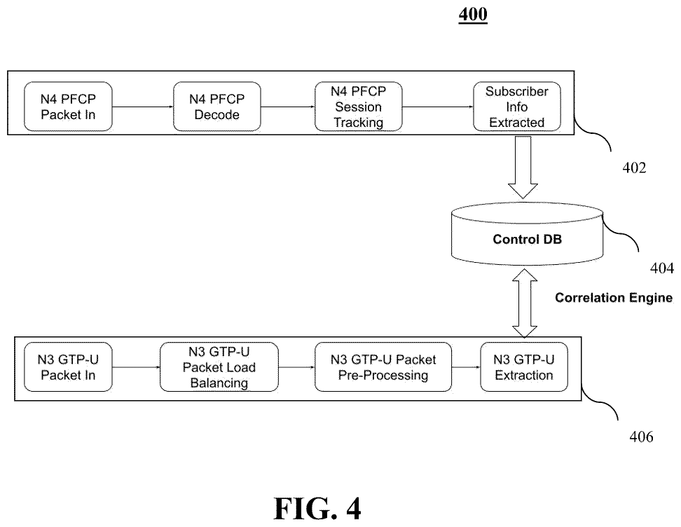

FIG. 4 shows an architecture flow according to an embodiment of the present disclosure. Packet extraction module 402 is responsible for extracting control information and storing it in control DB 404. Each PFCP session exchanged between SMF and UPF carries a unique Session identifier called SEID which is equivalent to PDU sessions created over other 5G networks interfaces via N2, N11, or other suitable channels. According to this embodiment, packet extraction module 402 first receives and decodes a packet over the N4 channel such as a PFCP packet. According to an embodiment, packet extraction module 402 tracks each of the PFCP sessions for the Subscriber (IMSI) based on the SEIDs, Sequence numbers exchanged in Control packets and extracts all the subscriber information like IMSI, IMEI, MSISDN, ULI, GTP-U F-TEID information of UPF and RAN.

Once the subscribed information has been extracted, packet extraction module stores control information into an efficient Control DB 404.

Correlation engine 406 is responsible for receiving GPTU packets and extracting tunnel information. According to an embodiment, upon reception of N3 GTP-U packets, the tunnel information is extracted after load-balancing and packet preprocessing. The extracted tunnel information is matched, by correlation engine 406, with the correct subscriber information from Control DB using efficient hash techniques.

Correlation engine 406 is capable of performing actions with the help of Correlated data like metadata extraction, exporting to 3rd party analyzers/tools, Subscriber aware load balancing, and similar functions.

By introducing these methods, the Control-User Correlation is attained on 5G Telco networks based on N4 PFCP interface. Leveraging the DPDK and Lockless Multi-Core Architecture, the system provides a scalable, efficient solution for High-speed packet correlation. Overall, this solution helps in achieving High Network Visibility and solving use cases like subscriber whitelisting, threat prevention, billing, performance monitoring, KPIs and resource allocation etc., Control packets exchanged before initiating the user plane sessions should be tapped and analyzed to extract the below relevant information.

According to a further embodiment, packet extraction module 402 analyzes the control packets (PFCP from N4 interface) and extracts the subscriber information needed for correlation. Subscriber information includes identifiers such as IMSI and IMEI, along with ULI and UE Info. Packet extraction module 402 also extracts F-TEIDs allocated for modules in GTP-U N3 packets, as well as User-TEIDs. The RAN and UPF are involved in handling data, while Control SEIDs of the N4 interface are managed by the SMF and UPF. According to an embodiment, the extracted subscriber information is maintained in Control DB 404 with F-TEID as Hashed Key and Subscriber information as value. It can be appreciated that an efficient lookup can be achieved here since the F-TEID is directly carried in GTP-U Packets.

According to an embodiment, correlation is achieved, by the correlation engine, by extracting the F-TEID from GTP-U packets and referencing the Control DB.

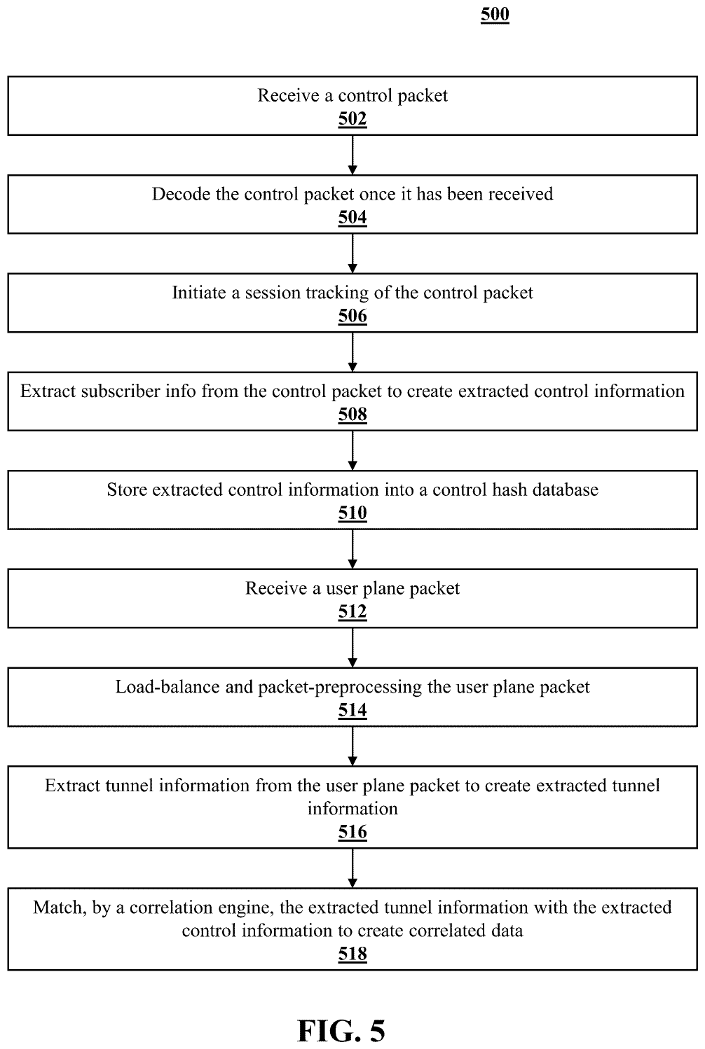

FIG. 5 is a flow chart of a process 500, according to an example of the present disclosure. According to an example, one or more process blocks of FIG. 5 may be performed by lockless multi-core system.

As shown in FIG. 5, process 500 may include receiving a control packet (block 502). For example, the lockless multi-core system may receive a PFCP packet over the N4 interface, as described above. As in addition shown in FIG. 5, process 500 may include decoding the control packet once it has been received (block 504). Decoding an N4 PFCP packet involves decoding various fields that convey instructions between the SMF and UPF.

As also shown in FIG. 5, process 500 may include initiating a session tracking of the control packet (block 506). Once the packet is decoded, the next step is to log its key parameters, like the PFCP message type, session ID, and TEID. By recording these details, you can track the session's state as the packet progresses through the network. For example, if the PFCP packet is part of a Session Establishment Request, you would monitor the system to ensure that the UPF correctly establishes the session as per the SMF's instructions. This involves checking that the session ID and TEID are properly allocated, and that the data path is set up according to the packet's directives.

Each PFCP session exchanged between SMF and UPF carries a unique Session identifier called SEID which is equivalent to PDU sessions created over other 5G networks interfaces via N2, N11 etc. This device tracks each of the PFCP sessions for the Subscriber (IMSI) based on the SEIDs, Sequence numbers exchanged in Control packets and extracts all the subscriber information like IMSI, IMEI, MSISDN, ULI, GTP-U F-TEID information of UPF and RAN.

As further shown in FIG. 5, process 500 may include Extracting subscriber info from the control packet to create extracted control information (block 508). For example, the method may extract subscriber info from the control packet to create extracted control information, as described above. As in addition shown in FIG. 5, process 500 may include Storing extracted control information into a control hash database (block 510). According to an embodiment, extracted control information is stored into an efficient Control Hash DB.

According to an embodiment, F-TEID is stored as a Hashed Key and Subscriber information as value. An efficient lookup can be achieved here since the F-TEID is directly carried in GTP-U Packets.

Next, the process continues to the reception of user plane packets and the correlation steps.

As also shown in FIG. 5, process 500 may include Receiving a user plane packet (block 512). For example, device may receive a GTP-U packet over the N3 channel, as described above. As further shown in FIG. 5, process 500 may include load-balancing and packet-preprocessing the user plane packet (block 514). Load balancing in the context of GTP-U packets involves distributing the incoming traffic across multiple processing cores or servers. This ensures that no single core or server becomes overwhelmed with too much data, which could lead to increased latency or even packet loss. Load balancing algorithms can be based on various factors, such as the current load on each core, the specific type of traffic, or predefined policies. For example, a GTP-U Inner Tuples might distribute packets evenly across cores, while alternative methods could take into account the specific requirements of different types of data flows, such as prioritizing latency-sensitive traffic. Packet preprocessing can include tasks such as inspecting the GTP-U header, extracting the TEID (Tunnel Endpoint Identifier), and verifying that the packet meets the expected format and security requirements. By preprocessing packets, the network can quickly identify and discard any malformed or unauthorized traffic, ensuring that only valid packets proceed to the next stage of processing. This combination of load balancing and packet preprocessing ensures that the network can handle large volumes of GTP-U traffic efficiently.

As in addition shown in FIG. 5, process 500 may include extracting tunnel information from the user plane packet to create extracted tunnel information (block 516).

For example, the F-TEID can be extracted from the GTP-U packet as described above. As also shown in FIG. 5, process 500 may include matching, by a correlation engine, the extracted tunnel information with the extracted control information to create correlated data (block 518). The extracted tunnel information is matched with the correct subscriber information from Control DB using efficient hash techniques. For example, the F-TEID As further shown in FIG. 5, process 500 may include executing, by the correlation engine, a performance action (block 520). For example, the method may execute, by the correlation engine, a performance action like metadata extraction, exporting to 3rd party analyzers/tools, Subscriber aware load balancing, and similar functions.

Process 500 may include additional implementations, such as any single implementation or any combination of implementations described below and/or in connection with one or more other processes described elsewhere herein. In a first implementation, the control packet may include a N4 PFCP packet.

In a second implementation, alone or in combination with the first implementation, the user plane packet may include a N3 GTP-U packet.

In a third implementation, alone or in combination with the first and second implementation, the extracted tunnel information is matched with the extracted control information using a hash technique, and where the extracted tunnel information may include an F-TEID value.

In a fourth implementation, alone or in combination with one or more of the first through third implementations, the performance action further may include a metadata extraction.

In a fifth implementation, alone or in combination with one or more of the first through fourth implementations, the performance action further may include a subscriber aware load balancing.

It should be noted that while FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

The foregoing disclosure provides illustration and description but is not intended to be exhaustive or to limit the implementations to the precise form disclosed. Modifications may be made in light of the above disclosure or may be acquired from practice of the implementations. As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, and/or the like, depending on the context. Although particular combinations of features are recited in the claims and/or disclosed in the specification, these combinations are not intended to limit the disclosure of various implementations. In fact, many of these features may be combined in ways not specifically recited in the claims and/or disclosed in the specification.

Although each dependent claim listed below may directly depend on only one claim, the disclosure of various implementations includes each dependent claim in combination with every other claim in the claim set. No element, act, or instruction used herein should be construed as critical or essential unless explicitly described as such. Also, as used herein, the articles “a” and “an” are intended to include one or more items and may be used interchangeably with “one or more.”Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method, comprising:
receiving a control packet;
decoding, by a multi-core architecture, the control packet once it has been received;
initiating a session tracking of the control packet;
extracting subscriber information from the control packet to create extracted control information;
storing the extracted control information into a control hash database;
receiving a user plane packet;
load-balancing and packet-preprocessing the user plane packet;
extracting tunnel information from the user plane packet to create extracted tunnel information;
matching, by a correlation engine, the extracted tunnel information with the extracted control information to create correlated data;
executing, by the correlation engine, a performance action.

2. The method of claim 1, wherein the control packet further comprises a N4 PFCP packet.

3. The method of claim 2, wherein the user plane packet further comprises a N3 GTP-U packet.

4. The method of claim 3, wherein the extracted tunnel information is matched with the extracted control information using a hash technique, and wherein the extracted tunnel information comprises an F-TEID value that is stored as a hash key in the control hash database.

5. The method of claim 2 wherein the performance action further comprises a metadata extraction.

6. The method of claim 2, wherein the performance action further comprises a subscriber aware load balancing.

7. A device comprising:
one or more processors configured to:
receive a control packet;
decode the control packet once it has been received;
initiate a session tracking of the control packet;
extract subscriber information from the control packet to create extracted control information;
store the extracted control information into a control hash database;
receive a user plane packet;
preprocess the user plane packet;
extract tunnel information from the user plane packet to create extracted tunnel information;
match, by a correlation engine, the extracted tunnel information with the extracted control information to create correlated data;
execute, by the correlation engine, a performance action.

8. The device of claim 7, wherein the control packet further comprises a N4 PFCP packet.

9. The device of claim 8, wherein the user plane packet further comprises a N3 GTP-U packet.

10. The device of claim 9, wherein the extracted tunnel information is matched with the extracted control information using a hash technique, and wherein the extracted tunnel information comprises an F-TEID value that is stored as a hash key in the control hash database.

11. The device of claim 8, wherein the performance action further comprises a metadata extraction.

12. The device of claim 8, wherein the performance action further comprises a subscriber aware load balancing.

13. A non-transitory computer-readable medium storing a set of instructions, the set of instructions comprising:
one or more instructions that, when executed by one or more processors of a device, cause the device to:
receive a control packet;
decode, by a multi-core architecture, the control packet once it has been received;
initiate a session tracking of the control packet;
extract subscriber information from the control packet to create extracted control information;
store the extracted control information into a control hash database;
receive a user plane packet;
load-balance and packet-preprocessing the user plane packet;
extract tunnel information from the user plane packet to create extracted tunnel information;
match, by a correlation engine, the extracted tunnel information with the extracted control information to create correlated data;
execute, by the correlation engine, a performance action.

14. The non-transitory computer-readable medium of claim 13, wherein the control packet further comprises a N4 PFCP packet.

15. The non-transitory computer-readable medium of claim 14, wherein the user plane packet further comprises a N3 GTP-U packet.

16. The non-transitory computer-readable medium of claim 15, wherein the extracted tunnel information is matched with the extracted control information using a hash technique and wherein the extracted tunnel information comprises an F-TEID value that is stored as a hash key in the control hash database.

17. The non-transitory computer-readable medium of claim 14, wherein the performance action further comprises a metadata extraction.

18. The non-transitory computer-readable medium of claim 14, wherein the performance action further comprises a subscriber aware load balancing.
